(19) United States
(12) Patent Application Publication
(10) Pub. No.: US 2021/0337975 A1
(43) Pub. Date: Nov. 4, 2021

(54) Modular, Compact, Stackable Beds And Associated Systems And Methods

(71) Applicant: Holt Sales and Service, LLC, Des Moines, IA (US)

(72) Inventor: Scott Drever, Des Moines, IA (US)

(21) Appl. No.: 17/245,832

(22) Filed: Apr. 30, 2021

Related U.S. Application Data
(60) Provisional application No. 63/018,076, filed on Apr. 30, 2020.

(51) Int. Cl. A47C 19/00; A47C 20/16; A47C 19/02; A47C 21/08; A47C 19/04

(52) U.S. Cl. CPC A47C 19/005; A47C 20/16; A47C 19/022; A47C 19/04; A47C 19/028; A47C 21/08; A47C 19/024

(57) ABSTRACT

The disclosed apparatus, systems and methods relate to stackable, foldable beds. The modular, stacking and folding have folding legs and couplers and can be stacked into a column for compact efficient storage or rapidly deployed in the event of need. The beds provide a temporary storage solution and can have a variety of additional components for use in hospital settings.

### CROSS-REFERENCE TO RELATED APPLICATION(S)

This application claims the benefit of U.S. Provisional Application 63/018,076, filed Apr. 30, 2020, and entitled “Folding, Compact Stackable Bed,” which is hereby incorporated by reference in its entirety herein, for all purposes.

### TECHNICAL FIELD

Discussed herein are various devices, systems, and methods related to beds and systems and methods for assembling and storing beds.

### BACKGROUND

Various beds and methods for storage and assembly thereof are known and appreciated in the art. Yet, many of these known beds and methods for assembly are cumbersome, bulky, and. inefficient.

### BRIEF SUMMARY

Discussed herein are various devices, systems and methods relating to a stackable, compact bed for ease of deployment and storage.

In Example 1, a stackable bed system comprising a first modular bed, comprising a first side and a second side, a second modular bed, comprising a first side and a second side, and a plurality of couplers, each coupler comprising a first seat and a second seat, wherein the first modular bed and the second modular bed are capable of forming a column, wherein one of the plurality of couplers is disposed on each corner of the first modular bed, wherein the first seat of the coupler is engaged with the first side of the first modular bed, and wherein the second seat of the coupler is engaged with the second side of the second modular bed.

In Example 2, the stackable bed system of Example 1, further comprising a third modular bed having a first side and a second side, wherein the first modular bed, the second modular bed, and the third modular bed are capable of forming a column, wherein one of the plurality of couplers is disposed on each corner of the second modular bed, wherein the first seat of the coupler is engaged with the first side of the second modular bed, and wherein the second seat of the coupler is engaged with the second side of the third modular bed.

In Example 3, the stackable bed system of Example 1, wherein the first modular bed comprises a frame, a head support engaged with the frame, and one or more legs engaged with the frame.

In Example 4, the stackable bed system of Example 3, wherein the head support is an adjustable head support and is pivotally engaged with the frame.

In Example 5, the stackable bed system of Example 3, wherein the one or more legs are pivotally engaged with the frame as such to be capable of an extended position and a retracted position.

In Example 6, the stackable bed system of Example 3, wherein the first modular bed further comprises one or more safety rails configured to be engaged with the frame.

In Example 7, the stackable bed system of Example 1, further comprising a plurality of casters disposed on the second side of the first modular bed.

In Example 8, a compact, stackable bed system comprising: a plurality of modular beds, each modular bed comprising a frame, a head support, and a foot support, and a plurality of couplers, each coupler comprising a first seat and a second seat spaced apart from the first seat, wherein the plurality of modular beds are configured to be vertically stackable into a stacked column by insertion of one or more of the plurality of couplers between each of the plurality of modular beds.

In Example 9, the compact, stackable bed system of Example 8, wherein the stacked column has at least four couplers are disposed between each of the plurality of modular beds.

In Example 10, the compact, stackable bed system of Example 8, wherein the head support is an adjustable head support configured to be capable of being disposed at a plurality of angles with respect to the frame.

In Example 11, the compact, stackable bed system of Example 10, wherein the adjustable head support is adjustable via a first notched arm having one or more notches, the first notched arm pivotally engaged with the head support at its first end and the first notched arm engaged with a first locking bar via one of the one or more notches when the head support is in a raised configuration.

In Example 12, the compact, stackable bed system of Example 11, wherein the foot support is adjustable via a second notched arm having one or more notches, the second notched arm pivotally engaged with the foot support at its first end and the second notched arm engaged with a second locking bar via one of the one or more notches when the foot support is in a raised configuration.

In Example 13, the compact, stackable bed system of Example 8, further comprising an accessory attachment comprising an elongate pole, a bracket disposed at a first end of the elongate pole, the bracket shaped for engagement with the frame of one or more of the plurality of modular beds, and a hook disposed at a second end of the elongate pole.

In Example 14, the compact, stackable bed system of Example 13, wherein the elongate pole is a telescoping pole.

In Example 15, a stackable, modular bed comprising: a frame, an adjustable head support within the frame, a foot support within the frame, one or more legs pivotally engaged with the frame, wherein each of the one or more legs comprises an extended position and a retracted position, and a removeable accessory attachment, wherein the stackable, modular bed is configured to be vertically engaged with one or more further stackable, modular beds via one or more couplers.

In Example 16, the stackable, modular bed of Example 15, further comprising one or more handles extending from the adjustable head support.

In Example 17, the stackable, modular bed of Example 15, further comprising one or more side rails configured to be releasably engaged with the frame via a bracket.

In Example 18, the stackable, modular bed of Example 15, further comprising a plurality of casters, each of the casters configured to be releasably attached at an end of one of the one or more legs when the one or more legs are in the extended position.

In Example 19, the stackable, modular bed of Example 18, wherein each of the plurality of casters is configured to be releasably attached to a corner of the frame when the one or more legs are in the retracted position.

In Example 20, the stackable, modular bed of Example 15, further comprising an accessory attachment releasably engaged with the frame.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a bed with a mattress and raised head support, according to one implementation.

FIG. 2 is a perspective view of a bed, according to one implementation.

FIG. 3 is a perspective view of a bed with a mattress and raised head support, according to one implementation.

FIG. 4 is a side view of a bed with a mattress and raised head support, according to one implementation.

FIG. 5 is a top view of a bed with a mattress and raised head support, according to one implementation.

FIG. 6 is an end-long view of a bed, according to one implementation.

FIG. 7 is an exploded or disassembled view of a bed, according to one implementation.

FIG. 8 is an exploded or disassembled view of a bed, according to another implementation.

FIG. 9 is a perspective view of a frame, according to one implementation.

FIG. 10 is a perspective view of a frame, according to another implementation.

FIG. 11A is a top view of a frame, according to one implementation.

FIG. 11B is a side view of a frame, according to one implementation.

FIG. 11C shows a support flange, according to one implementation.

FIG. 11D shows a mattress stop, according to one implementation.

FIG. 12A is a perspective view of a bed with raised head and foot supports, according to one implementation.

FIG. 12B is a magnified view of the frame and head and foot support connections, according to one implementation.

FIG. 13A is a perspective view of a head support, according to one implementation.

FIG. 13B is a top view of a head support, according to one implementation.

FIG. 13C is a top view of a head support, according to another implementation.

FIG. 13D is a side view of the head support of FIG. 13B, according to one implementation.

FIG. 13E is a top view of a head support, according to one implementation.

FIG. 13F is a side view of the head support of FIG. 13E, according to one implementation.

FIG. 13G is an end-long view of the head support of FIG. 13E, according to one implementation.

FIG. 13H shows a joint between a corner brace and a brace, according to one implementation.

FIGS. 14A-B are perspective views of handles, according to certain implementations.

FIGS. 14C-D are side views of handles, according to certain implementations.

FIGS. 14E-F are perspective views of handles, according to certain implementations.

FIG. 15 shows a brace, according to one implementation.

FIG. 16 shows a corner brace, according to one implementation.

FIG. 17A is a perspective view of a bed, according to one implementation.

FIG. 17B shows an exploded view of a fastener, according to one implementation.

FIG. 17C shows a fastener, according to one implementation.

FIG. 18A is a top view of an incline lock, according to one implementation.

FIG. 18B is a perspective view of an incline lock, according to one implementation.

FIG. 18C-E are side views of notched arms, according to certain implementations.

FIG. 18F is an end-long view of an incline lock, according to one implementation.

FIG. 19A is a perspective view of a bed, according to one implementation.

FIG. 19B is a magnified view of a leg joint, according to one implementation.

FIG. 19C is an exploded view of a fastener, according to one implementation.

FIG. 20A is a front view of two legs and a cross bar, according to one implementation.

FIG. 20B is a perspective view of two legs and a cross bar, according to one implementation.

FIG. 20C is a side view of a leg, according to one implementation.

FIG. 20D is a top view of two legs and a cross bar, according to one implementation.

FIG. 21A are perspective views of leg brackets, according to one implementation.

FIG. 21B is a front view of a leg bracket, according to one implementation.

FIG. 21C is a side view of a leg bracket, according to one implementation.

FIG. 22 is a side view of a caster, according to one implementation.

FIG. 23A is a side view of an accessory attachment, according to one implementation.

FIG. 23B is a perspective view of an accessory attachment bracket and fastener, according to one implementation.

FIG. 23C is a perspective view of an accessory attachment fixation fastener, according to one implementation.

FIGS. 23D is a perspective view of an accessory attachment with a hook, according to one implementation.

FIG. 23E is a side view of an accessory attachment with a hook, according to one implementation.

FIG. 24A is a perspective view of a safety rail, according to one implementation.

FIG. 24B is a front view of a safety rail, according to one implementation.

FIG. 24C is a side view of a safety rail, according to one implementation.

FIG. 25 shows perspective views of couplers, according to one implementation.

FIGS. 26A-C are perspective views of stacked beds with couplers, according to certain implementations.

FIG. 26D is a side view of stacked beds with couplers, according to one implementation.

FIG. 26E is a top perspective view of stacked beds with couplers, according to one implementation.

### DETAILED DESCRIPTION

The various embodiments disclosed or contemplated herein relate to a stackable, foldable, modular bed system comprising one or more beds having optional support rails at the head, foot, and/or side of the bed. In various implementations, the system and bed(s) disclosed herein can be quickly deployed when additional bed capacity is required and, alternatively, easily stored in compact stacks via a series of couplers. Further, the plurality of beds are more comfortable than cots and capable of being efficiently stored and deployed for use.

As such, the various implementations of the system disclosed herein contemplate a space-efficient, deployable solution for several applications, such as in the event of disaster, evacuations, rapid deployments or displacements of people or other periodic need, such as in the case of student or worker programs and the like. Further applications would be readily apparent to those of skill in the art.

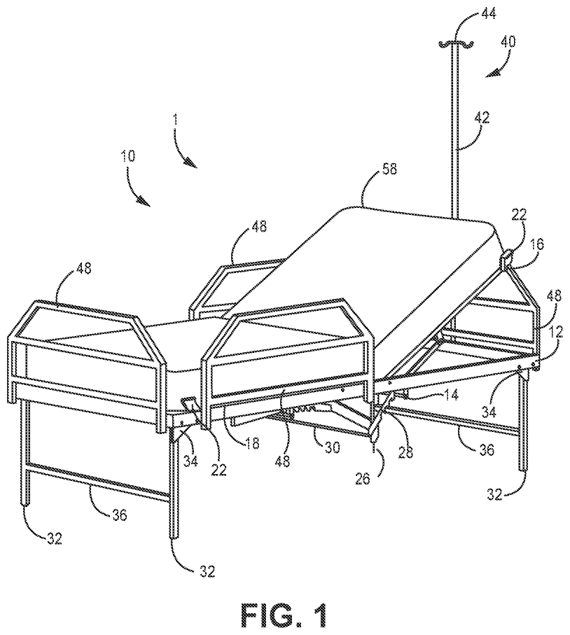

Turning to FIGS. 1-8 in greater detail, the foldable bed system 1 according to certain implementations includes a variety of components for the, many of which are optional. In certain implementations, the bed 10 is modular, in that it may easily be assembled and disassembled into its various constituent parts by laymen or other personnel, such as hospital staff. In various implementations, the bed 10 includes a frame 12, a head support 16, and a foot/leg support 18. In certain implementations, the head support 16 and/or foot support 18 are pivotally attached to the frame 12 such that the head support 16 and/or foot support 18 may be placed in an angled/raised position. Further various implementations may include optional support rails (also referred to herein as safety rails) 48 at the head, foot, and sides of the bed 10.

FIG. 1 specifically shows an implementation of the system 1 bed 10 with the head support 18 in an angled position and having support rails 48 at the head, foot, and on each side of the frame 18. In this particular implementation, the bed 10 includes a mattress 58 on top of the frame 12.

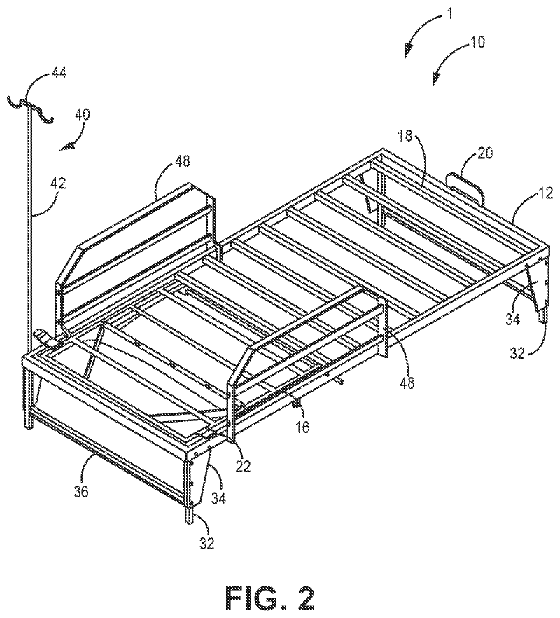

FIG. 2 shows an implementation of the bed 10 in a flat position and having support rails 48 on either side of the frame 12, as would be readily understood. In this and other implementations, the bed 10 includes a mattress stop 20, optionally disposed at the foot of the bed 10. In such implementations having the mattress stop 20, the mattress stop 20 is configured to stop a mattress 58 from sliding off of the frame 12 when the head support 16 is urged into an angled position (such as is shown in FIG. 1). In further implementations, a safety rail 48 placed to the foot of the bed 10 may act as a mattress stop 20.

Further, in this implementation, the system 1 has a bed 10 includes an accessory attachment 40, and more particularly an IV holder 40 including an elongate pole 42 and hook 44. It is readily apparent that further accessories such as breathing apparatuses, heart monitors and the like can also be fitted, and that the accessory attachment 40 can be configured or otherwise sized for such various uses. Further, in certain implementations, a plurality of accessory attachments 40 are provided.

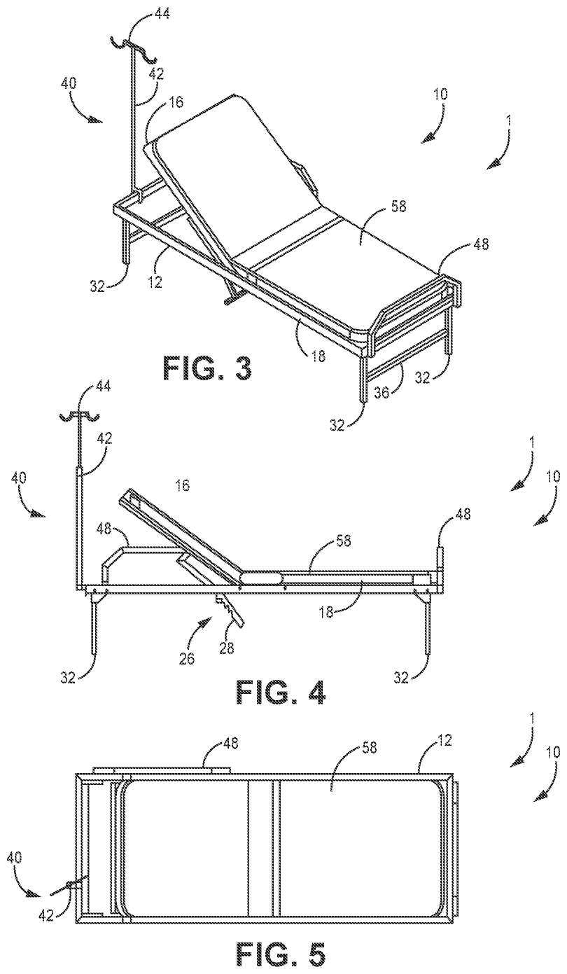

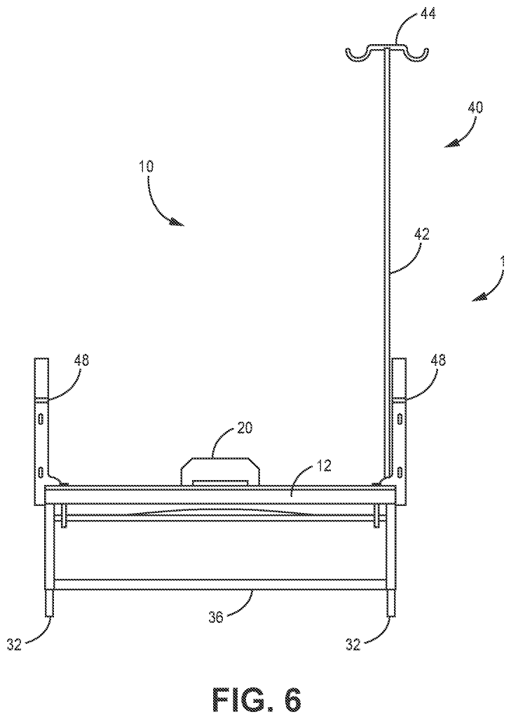

FIGS. 3-6 depict various alternative implementations of the bed 10 from various angles. These include a perspective view (FIG. 3), a side view (FIG. 4), a top view (FIG. 5), and an end-long view (FIG. 6).

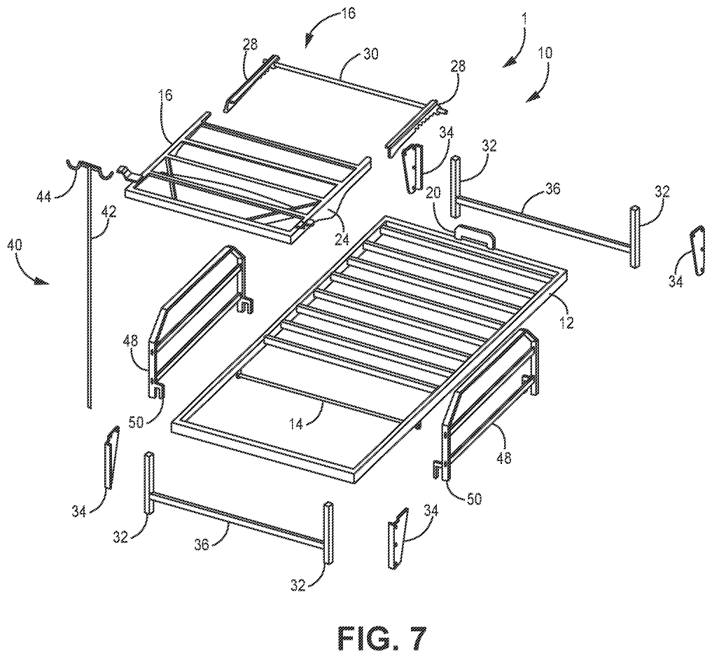

FIGS. 7 and 8 show exploded/disassembled views of the bed 10, according to certain implementations. In the implementation of FIG. 7, the bed 10 includes an adjustable head support 16, to be pivotally attached to the frame 12. The bed 10 further includes two support rails 48 for attachment on opposite sides of the frame 12, although alternative placements are possible. Legs 32, leg brackets 34, and an accessory attachment 40 are also provided.

In FIG. 8, the bed 10 includes an adjustable head support 16 and an adjustable foot support 18, each pivotally attached to the frame 12 in a manner to be described further below. This implementation further includes four support rails 48, one for each side of the frame 12 and one for the head of the bed 10 and one for the foot of the bed 10. An accessory attachment 40 is also provided.

Turning now to FIGS. 9-24C, in various implementations, during use of the system 1, the bed 10 or beds 10 may be assembled in a series of steps. As would be appreciated each step is optional and may be performed in any order or not at all.

During use of the system 1, in a first optional step the frame 12 is placed on a flat or otherwise stable surface with lock bars 14 facing down or toward the flat surface, as shown for example in FIGS. 9-11B. In the example of FIG. 9, the frame 12 is without a head support 16 or a foot support 18 which may be attached in a manner as will be described further below. FIG. 10 shows an alternative implementation of the frame 12, where the frame 12 includes an integral or fixedly attached foot support 18 and a space for insertion of an adjustable head support 16. Further, in this implementation, the bed 10/frame 12 includes a mattress stop 20 disposed at the foot-end of the frame 12.

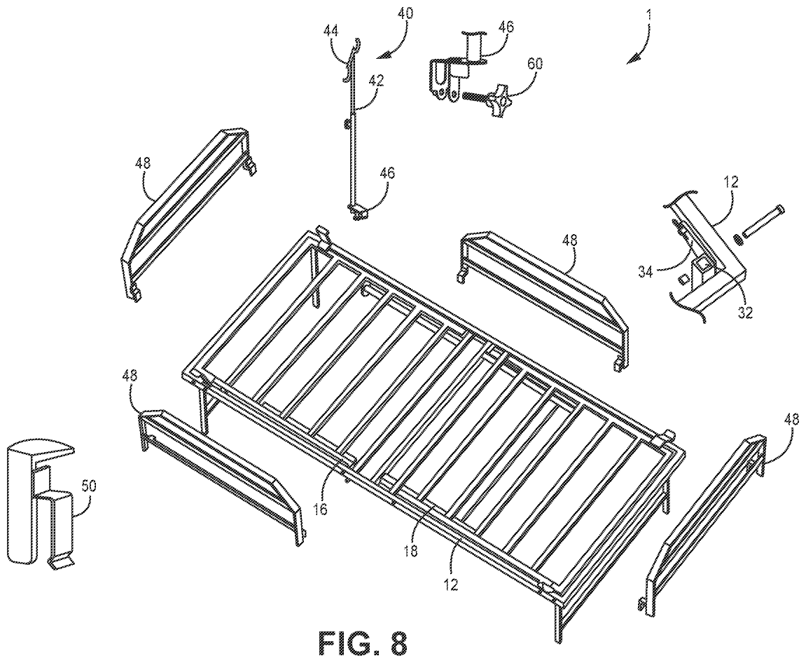

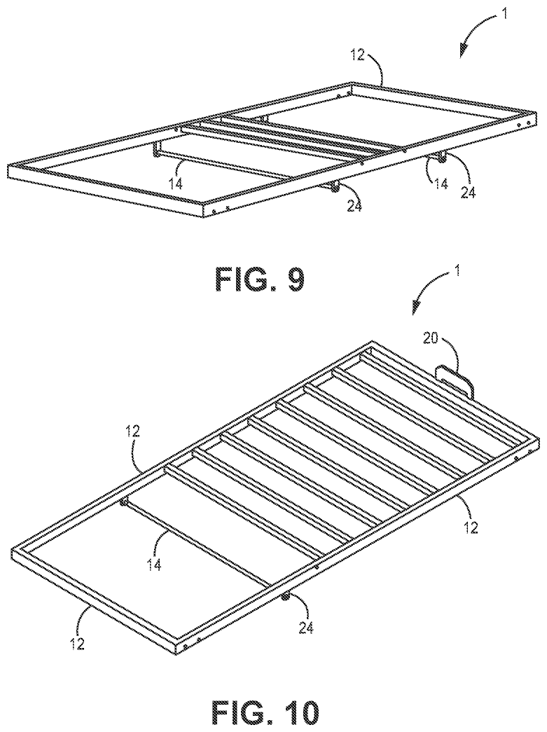

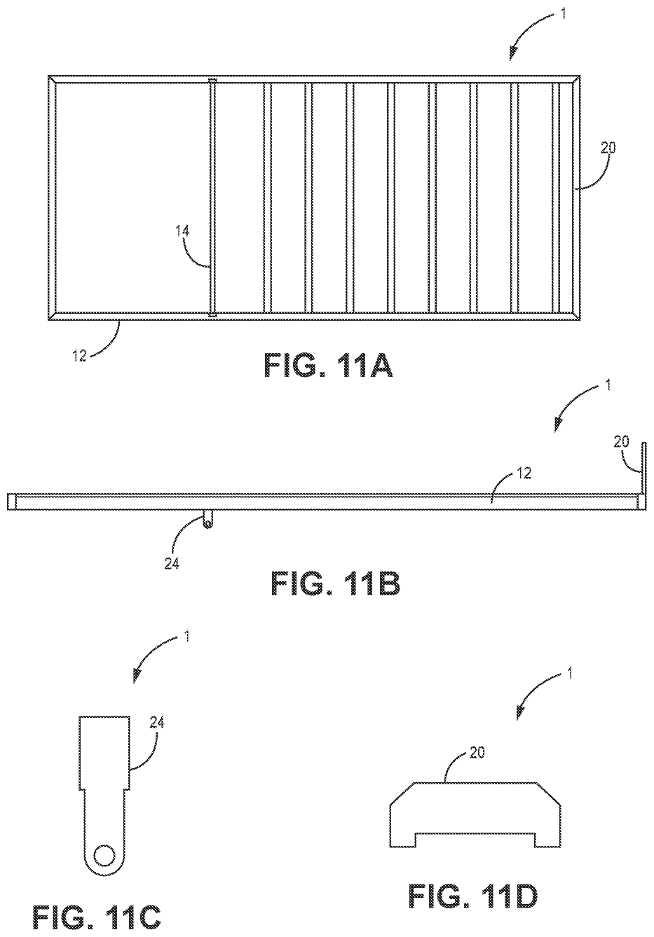

FIG. 11A shows a top view of the frame 12 of FIG. 10. FIG. 11B is a side view of the frame 12 of FIG. 10. In various implementations, such as those of FIGS. 9 and 10, the bed 10 includes locking flanges 24 extending from the frame 12. The locking flanges 24 may be arranged to be attached to and hold the locking rails 14. One exemplary implementation of a locking flange 24 is shown in FIG. 11C. An exemplary mattress stop 20 is shown in FIG. 11D.

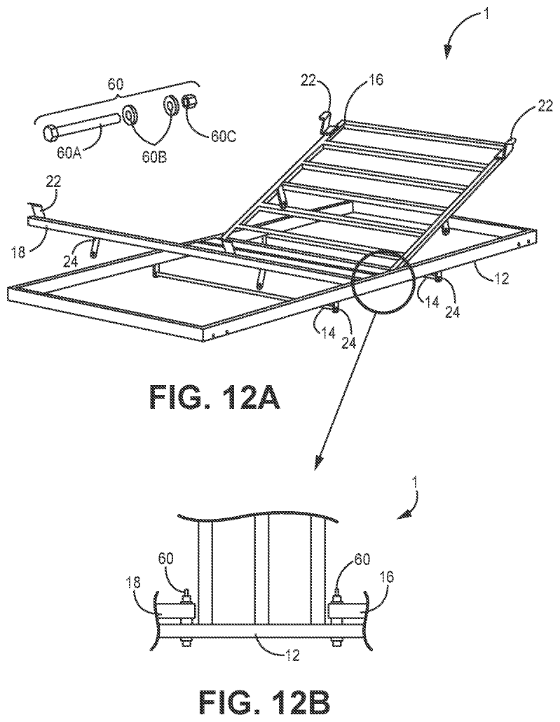

In a further optional step, the head support 16 and/or foot support 18 may be attached to the frame 12 via one or more fasteners 60, as shown in FIGS. 12A-B. In certain implementations, a fastener 60 may include a series of parts such as a bolt 60A, a washer 60B, and a nut 60C or various alternative combinations thereof as would be understood by those of skill in the art. A zoomed in view of the head support 16 and foot support 18 attached to the frame 20 via fasteners 20 is shown in FIG. 12B. In various implementations, the head support 16 and/or foot support 18 are rotatable about the joint formed with the frame 12.

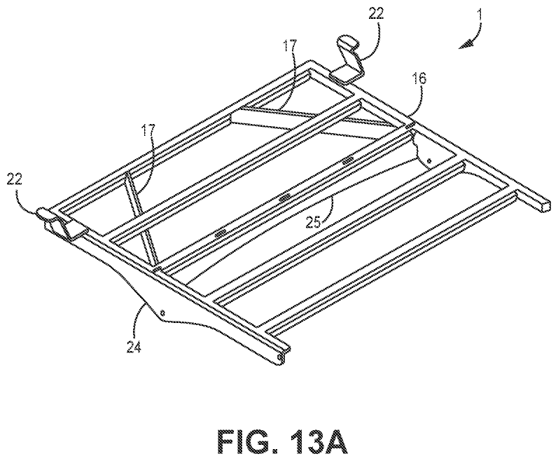

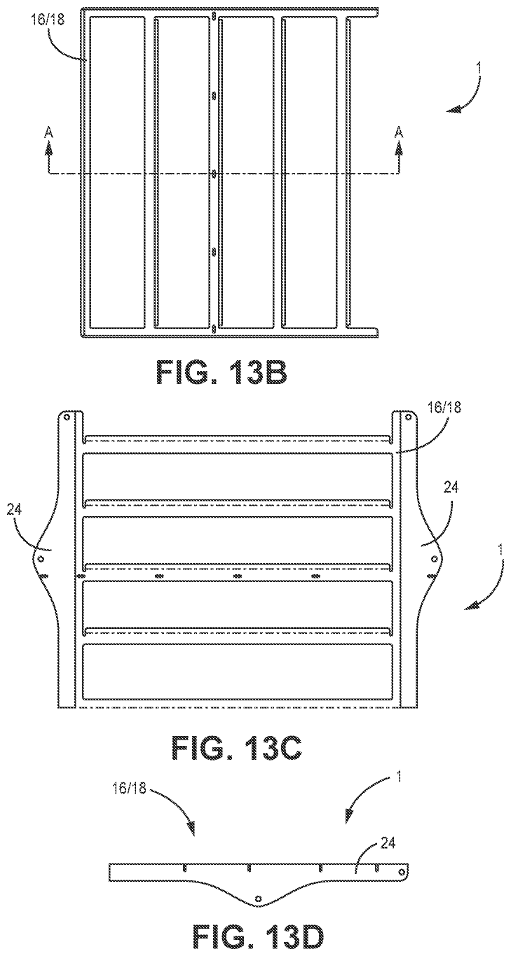

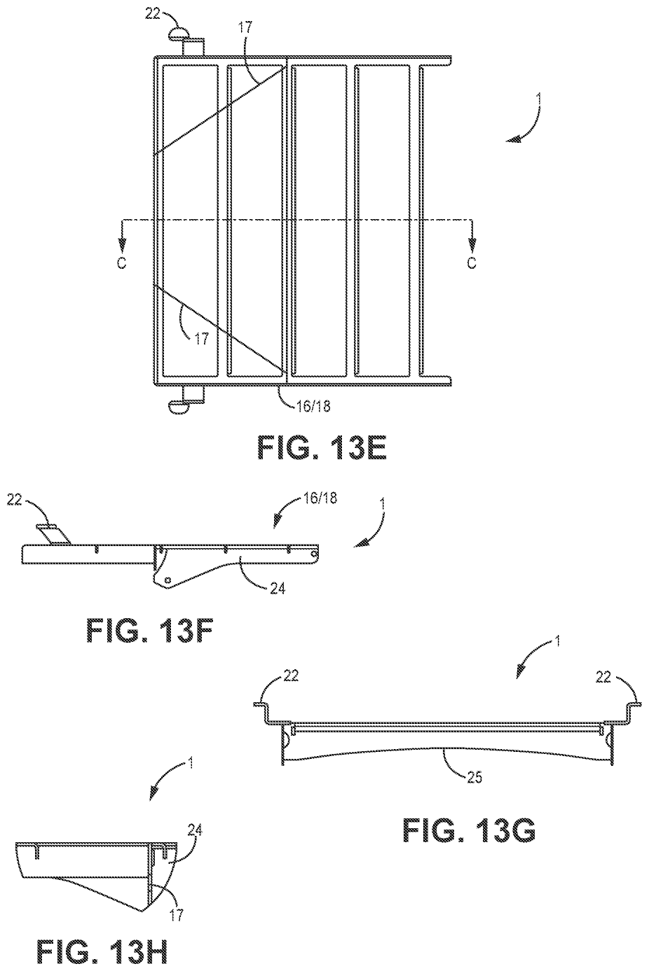

Various implementations and views of a head support 16 and/or foot support 18 are shown in FIGS. 13A-H. FIG. 13A shows a perspective view of a head support 16 having corner braces 17 configured to provide additional stability and to prevent deformity of the head support 16. Also, this implementation includes support flanges 24 disposed on opposite sides of the head support 16. In various implementations, the head support 16 includes a brace 25 extending between the support flanges 24. Further, in certain implementations, the head support 16 includes or more handles 22. In various implementations, the handles 22 are configured to extend from the head support 16 to facilitate lifting or urging the head support 16 into an angled or raised position (as shown for example in FIG. 1), adjusting the position of the head support 16, and/or returning the head support 16 to a neutral or flat position. It would be understood that various features described above and herein with respect to a head support 16 may also be present on the optional foot support 18, or vice versa.

FIG. 13B illustrates an alternative implementation of a head support 16 or foot support 18. FIG. 13C depicts a view of one implementation of the head support 16 where the support flanges 24 extend outward from the head support 16 prior to being folded or urged downward into their in-use position, at an about 90° angle from the head support 16. FIG. 13D depicts a side view of the head support 16 along cross section A-A of FIG. 13B.

FIG. 13E depicts a further implementation of a head support 16 or foot support 18 having braces 17 and handles 22. FIG. 13F depicts a side view of the head support of FIG. 13E. FIG. 13G depicts and end-long view of the head support 16 of FIG. 13E showing an optional brace 25. FIG. 13H shows one configuration of a joint between a corner brace 17 and brace 25. In various implementations, the corner brace 17 and brace 25 are fitted together via one or more slots.

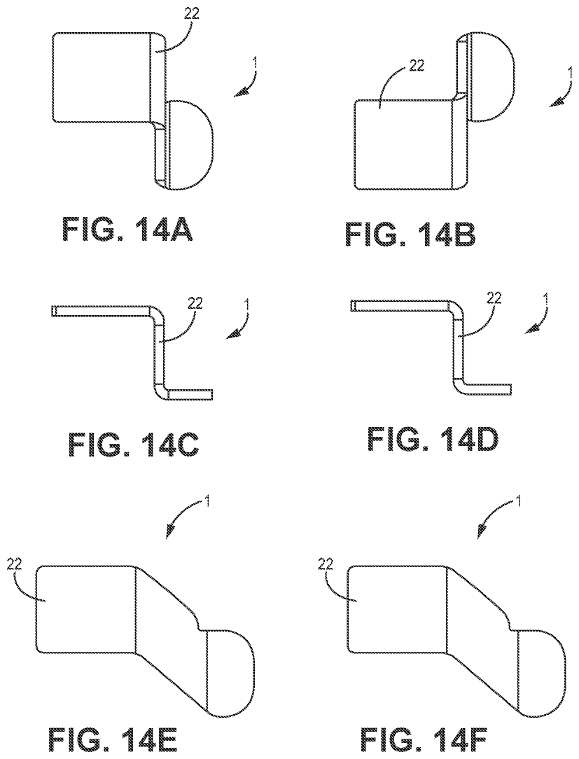

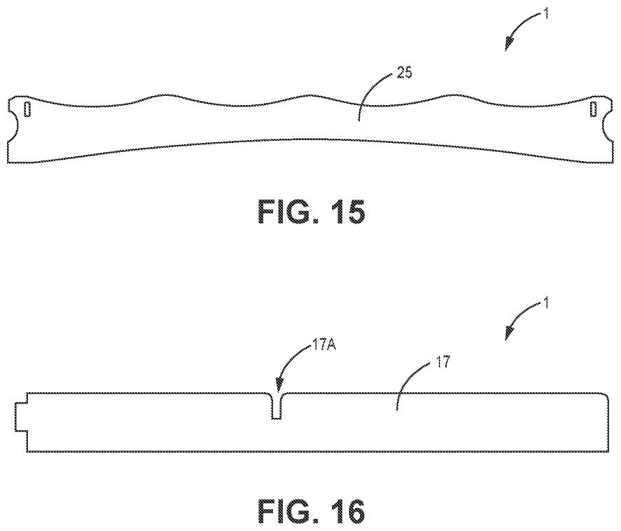

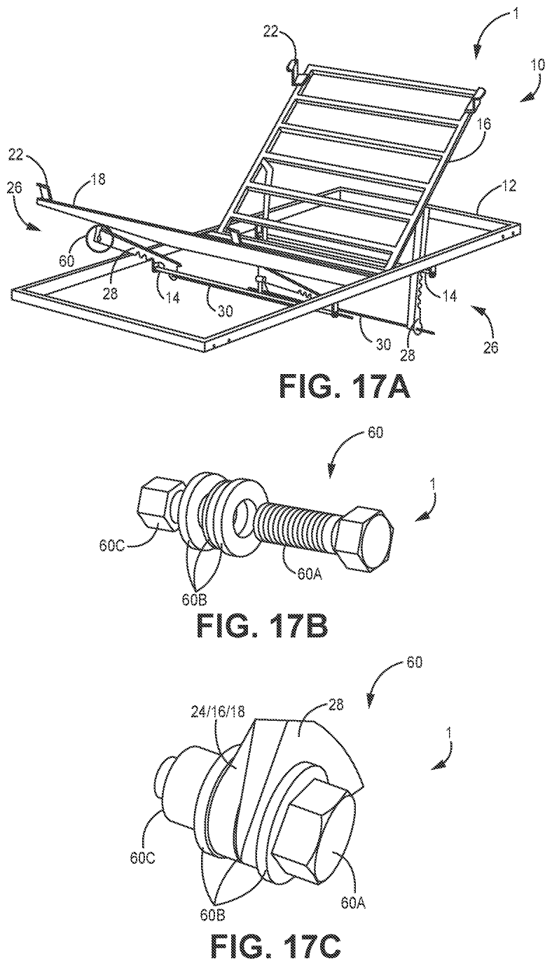

FIGS. 14A-F show various views and implementations of optional handles 22. As discussed above, the optional handles 22 are configured to extend outward from a head support 16 or foot support 18 to facilitate the raising or lowering of the head support 16 or foot support 18. FIG. 15 depicts an optional brace 25. As previously discussed, in various implementations, the brace 25 extends across the width of the head support 16 substantially between support flanges 24. FIG. 16 shows the optional corner brace 17, with slot 17A for forming a joint with the optional brace 15, as discussed above.

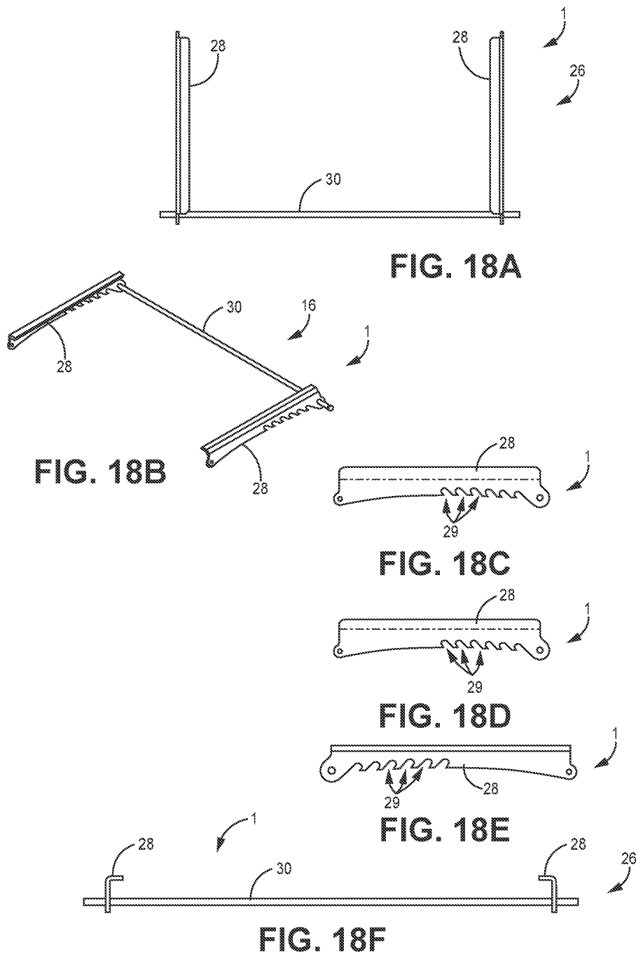

Turning now to FIGS. 17A-18F, in another optional step, the locking arms 14 may be operatively engaged with the head support 16 and foot support 18 via one or more additional fasteners 60 and an incline locker 26. In various implementations, the incline locker 26 includes one or more notched arms 28 and optionally a cross bar 30 extending substantially between two or more notched arms 28.

In various implementations, the one or more notched arms 28 are attached to a support flange 24 via one or more fasteners 60, such as the fasteners 60 shown in FIG. 17B. In various implementations, the fastener 60 may include a bolt 60A, one or more washers 60B, and a nut 60C. In certain implementations, the fastener 60 includes a washer 60B disposed between the arm 28 and the head support 16/foot support 18, as shown in FIG. 17C. In various implementations, the notched arms 28 are configured to rotate about the joint formed by the fastener 60 with the support flange 24.

FIG. 18A shows one exemplary implementation of an incline locker 26 having two notched arms 28 and a cross bar 30. FIG. 18B shows a perspective view of the incline locker 26 of FIG. 18A. FIGS. 18C-E shows various implementations of the notched arms 28. As would be understood, the notched arms 28 include or more notches 29 shaped within the arm 28. In various implementations, the notches 28 are shaped to engage with a locking rail 14, as shown for example in FIG. 17A. Turning to FIG. 18F, an end-long view of the incline locker 26 is shown.

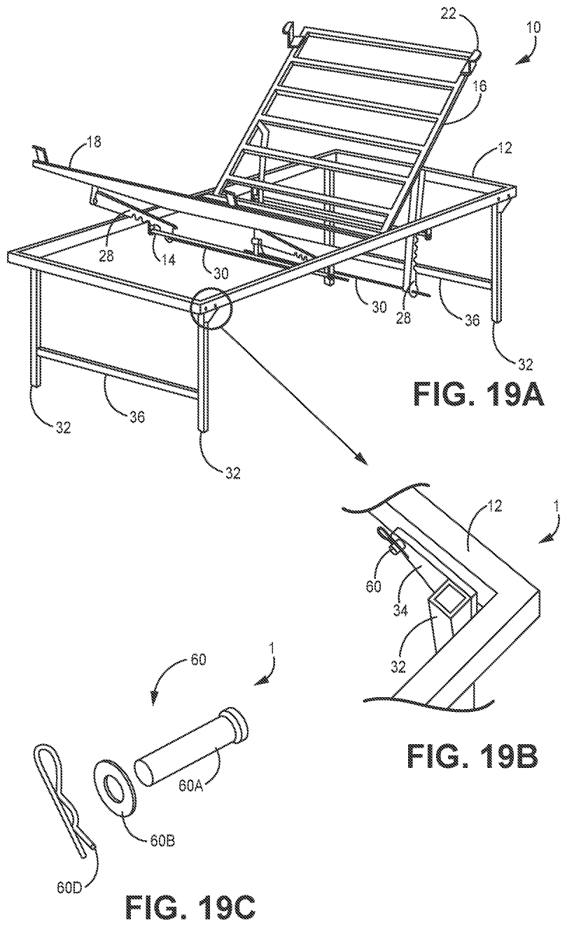

In a still further optional step, shown for example in FIGS. 19A-21C, legs 32 are attached to the frame 12. In various implementations, the legs 32 may be releasably engaged with the frame 12. In a still further implementation, the legs 32 are pivotally engaged with the frame 12 such that the legs 32 may be in an extended or deployed position or in a retracted or storage position. In various implementations, the elongate legs 32 are substantially square, hollow tubes, having an attached flange 34.

In certain implementations, the legs 32 may optionally include a flange 34, shown for example in FIG. 19B. The flange 34 may be integral with a leg 32, in certain implementations. In various implementations, the legs 32 and/or the optional flange 34 are attached to the frame 12 via one or more fasteners 60, such as the fastener 60 shown for example in FIG. 19C. In certain implementations, the fastener 60 includes a bolt 60A, a washer 60B, and a pin 60D, although other configurations are of course possible and would be understood by those of skill in the art.

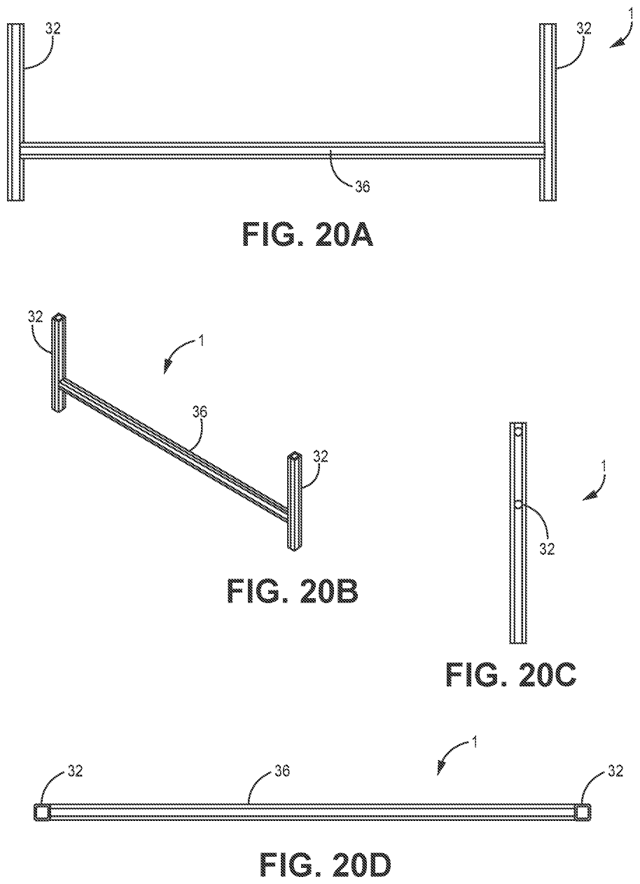

FIGS. 20A-D show various views of legs 32. In certain implementations, two or more legs 32 are attached by a cross bar 36. In these implementations, the cross bar 36 may be integral with the two or more legs 32 or may be otherwise attached to the legs 32.

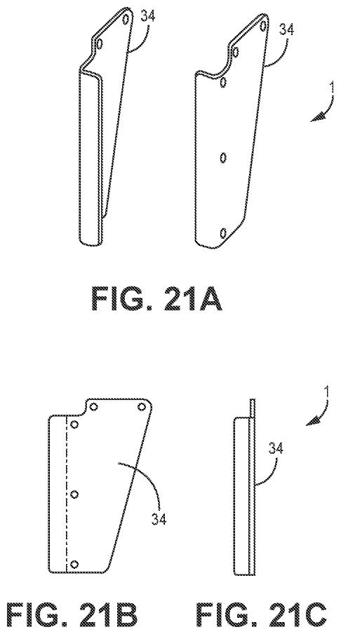

FIGS. 21A-C depict various views of the optional flange 34. In certain implementations, as discussed above, the flange 34 facilitates optional rotation of the legs 32 with respect to the frame 12, as would be understood.

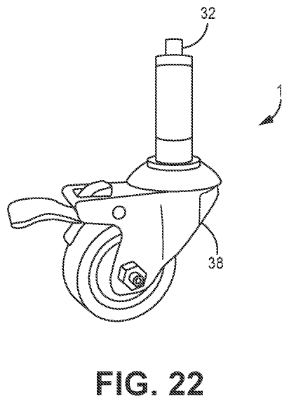

In various implementations, the bed 10 may include optional casters 38, as shown in FIG. 22. In these and other implementations, the casters 38 may be engaged with the frame 12 and/or legs 32 of a bed 10 for ease of movement. Various casters 38 and attachment mechanisms for the casters 38 would be known to those of skill in the art.

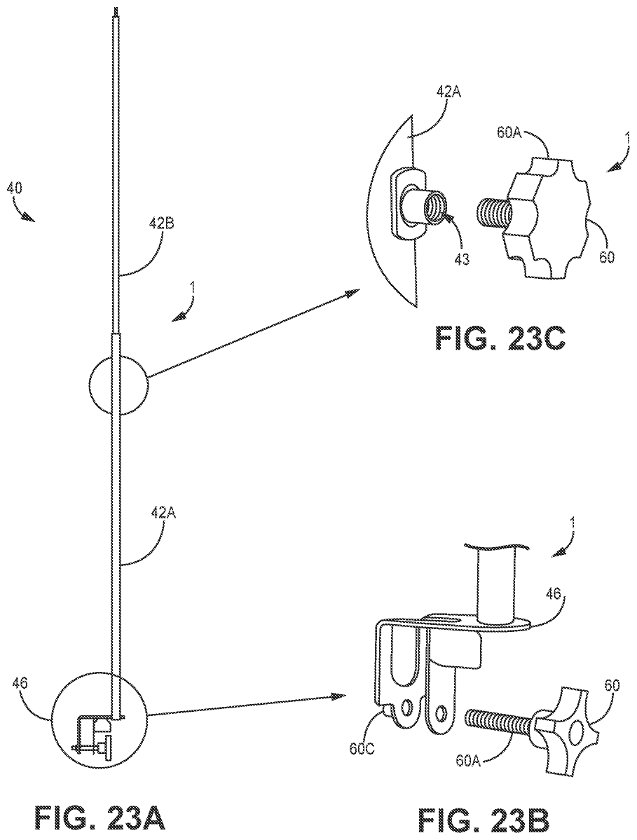

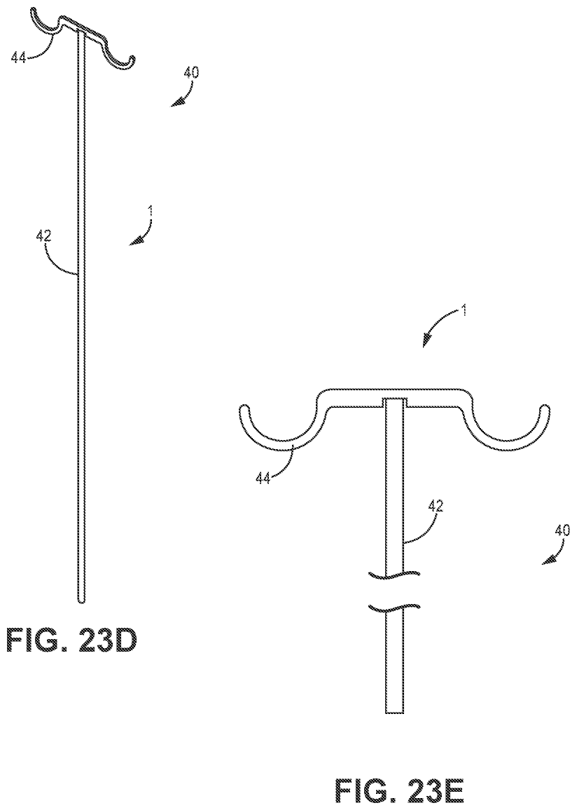

In another optional step, an intravenous (“IV”) fluid holder 40 or other accessory attachment 40 is releasably attached to the frame 12, as shown in FIGS. 23A-E. In these and other implementations, the accessory attachment 40 is secured to the frame via a bracket 46 and a related fastener(s) 60. In some implementations, a bolt 60A is inserted though the bracket 46 and secured with a nut 60C.

In certain implementations, the accessory attachment 40 may be telescopic or otherwise collapsible or configured of multiple parts—such as an outer rod 42A and an inner rod 42B. In certain of these implementations, the telescopic accessory holder 40 is held in an extended configuration via a fastener 60, such as a bolt 20A screwed into an opening 43 whereby an inner rod 42B is secured in a set position relative to the outer rod 42B, as would be understood. Various alternative fixation mechanism for a telescoping or otherwise adjustable rod 42 would be recognized by those of skill in the art.

Continuing with FIGS. 23D-E, in various implementations, the accessory attachment 40 may include an optional hook 44. In certain implementations, the hook 44 is configured to hold one or more bags of IV fluid, although other uses are possible and would be recognized by those of skill in the art. Additional components, styles, and uses of the accessory attachment 40 would be appreciated by those of skill in the art in light of this disclosure. For example, the accessory attachment 40 may be configured to hold a heart monitor and/or a breathing machine. In another example, the accessory attachment 40 may be configured to hold luggage or clothing. In a still further example, the accessory attachment 40 may include a light, an alarm, and/or other electronic mechanism.

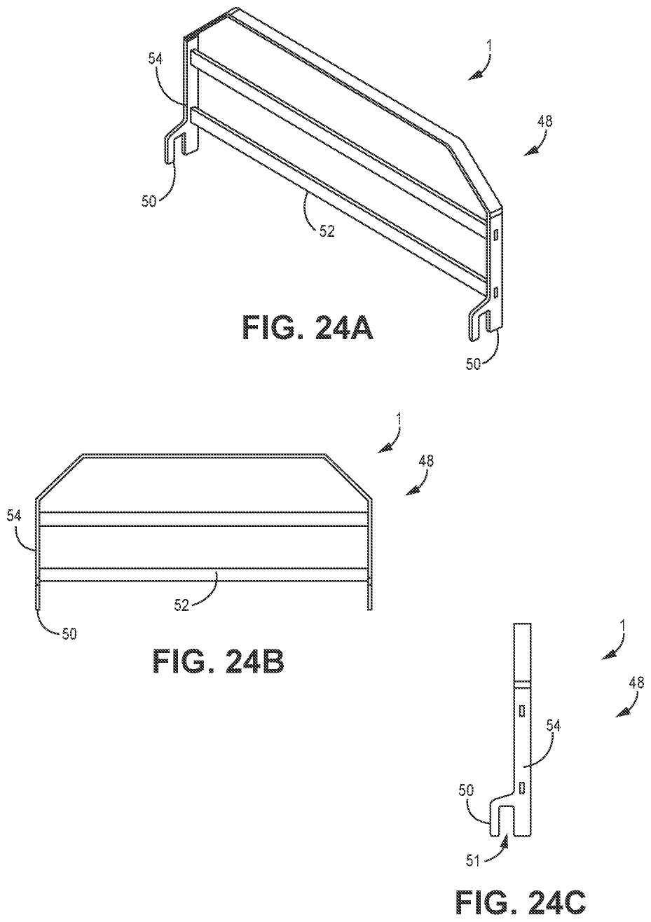

In a further optional step, the bed 10 may be assembled with optional support rails 48, as shown in FIGS. 24A-C. In various implementations, the bed 10 includes one or more support rails 48, that may be secured in a variety of locations on the bed 10/frame 12. For example, a support rail 48 may be placed at the head of the bed 10, at the foot of the bed 10, or along the side of the bed 10 to prevent a patient or other user from falling off the bed 10.

Various configurations of support rails 48 would be recognized by those of skill in the art. In certain implementations the support rails 48 include one or more upright portions 54 and one or more cross bar portions 52. Further, in certain implementations, the support rails 48 include brackets 50 for engagement with the frame 12. In certain implementations, the brackets 50 include a notch or cutout 51 shaped to engage the frame 12 such that the support rail 48 may be easily slid onto and off of the frame 12 vertically, but will not fall off the frame 12 when lateral pressure is applied, as would be understood.

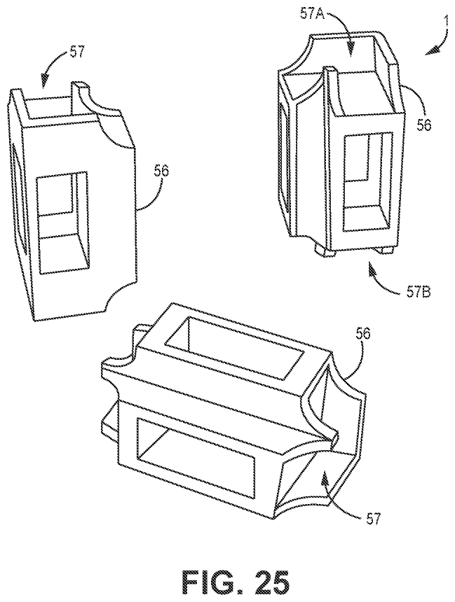

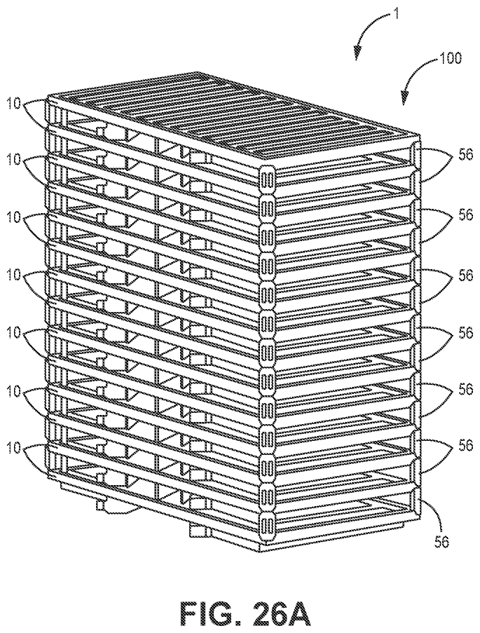

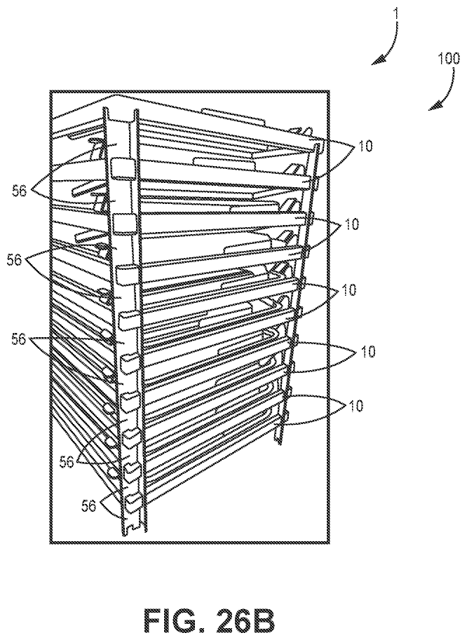

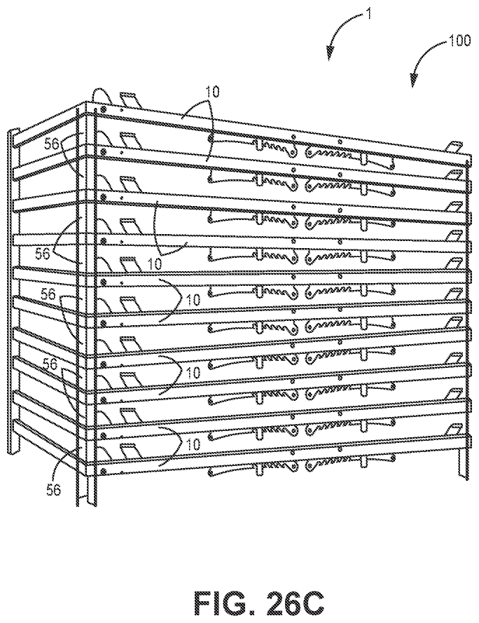

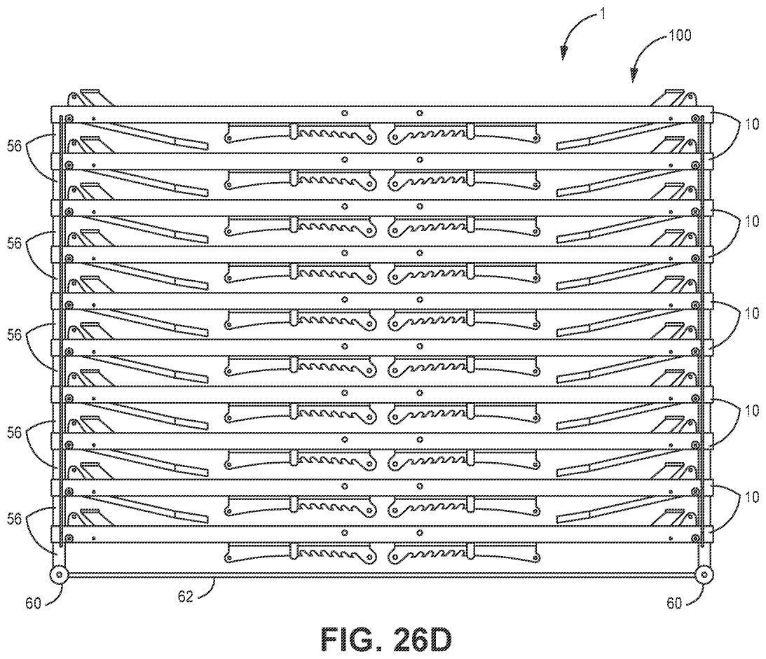

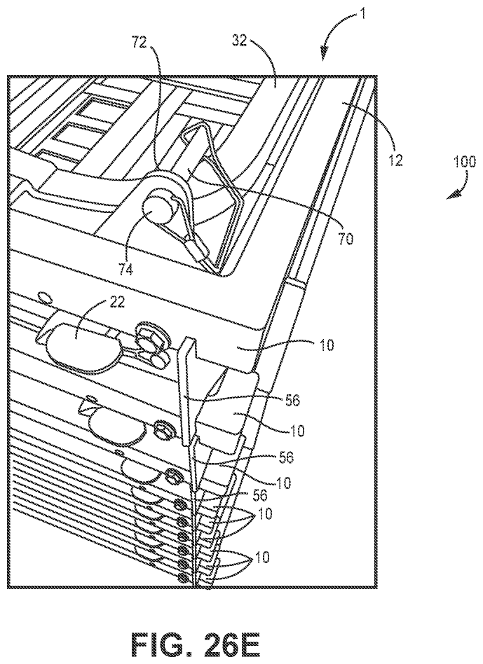

In use according to certain implementations, the beds 10 are stackable, as shown in FIGS. 25-26E. In various implementations, the beds 10 may be secured in a stacked configuration via one or more modular couplers or coupling blocks 56 like that shown in FIG. 2E. In various implementations, the couplers 56 can comprise one or more defined openings and/or flanges, and are shaped or otherwise configured to fit snugly with the frame 12 such that a coupler 56 may sit on top of one frame 12 and a second frame 12 may fit within a defined opening or seat 57. It is appreciated that in these implementations, rather than providing a defined structure for the securement of the various beds 10, these modular couplers 56 are used in conjunction with the bed frames 12 to erect a structure for storage of the beds, shown generally at the bed assembly 100 shown in FIGS. 26A-26E. That is, the combination of beds 10 with couplers 56 disposed at each corner can be stacked to create the bed assembly column 100, such as in a storage room or other area.

In such implementations, one or more couplers 56 are provided to allow for the stacking of several beds 10 in a compact column that can be stored between uses, such as for emergencies like pandemics, natural disasters, evacuations, and rapid deployments or displacements of large numbers of people. In these implementations, before or after use several beds 10 can be stacked in such a column 100 in various states of assembly to allow for ease of storage and deployment in a time of need, as would be readily appreciated. In various implementations, beds 10 may be stacked such that a column 100 of beds 10 includes 5, 6, 7, 8, 9, 10 or more beds 10 and a corresponding number of modular couplers 56 configured to secure those beds 10 in a column 100. It would be apparent to those of skill in the art that N beds can be stacked using [(N−1)×4] couplers 56. That is, as shown in the implementation of FIG. 26A, 14 beds are stacked using (13×4)=52 couplers 56. Further implementations are of course possible, and in alternate implementations, couplers 56 are additionally provided under the lowest bed 10 to serve as legs.

As shown in FIGS. 26A-E, a series of beds 10 may be stacked by first placing one coupler 56 on each of the four corners of a frame 12, such that the first side of the frame sits within the first seat 57A. A second side of a second bed 10 frame 12 may be inserted into the second seat 57B such that the second bed 10 is substantially vertically stacked on top of the first bed 10. Another set of couplers 10 may then be placed on each of the corners on the first side of the frame 12 of the second bed 10 where the first side of the frame 12 sits within the first seat 57A. A third bed 10 may then be stacked vertically on top of the second bed 10 in substantially the same manner as previously described.

As shown in the implementation of FIG. 26D, in certain implementations of the system 1, the beds 10 may be stacked into a column 100 via couplers 56, and the column 100 can be disposed atop one or more wheels 60 for movement, as would be readily appreciated. In various implementations, a support brace 62 is provided with wheels 60 to build the column 100 upon, though in alternate implementations the wheels 60 are provided as modular components capable of being attached to the couplers 56 and/or underside of the bottom bed 10, as would be readily appreciated.

As shown in the implementation of FIG. 26E, in various implementations, a securement pin 70 or other closure can be used to secure the legs 32 in a locked position parallel to the frame 12, as would be readily appreciated. In the implementation of FIG. 26E, the pin 70 is disposed through an opening 74 in a support flange 72, as would be readily understood. Further securement mechanisms are of course possible.

Although the disclosure has been described with reference to preferred embodiments, persons skilled in the art will recognize that changes may be made in form and detail without departing from the spirit and scope of the disclosed apparatus, systems and methods.

What is claimed is:

1. A stackable bed system comprising:
(a) a first modular bed, comprising a first side and a second side;
(b) a second modular bed, comprising a first side and a second side; and
(c) a plurality of couplers, each coupler comprising a first seat and a second seat,
wherein the first modular bed and the second modular bed are capable of forming a column, wherein one of the plurality of couplers is disposed on each corner of the first modular bed, wherein the first seat of the coupler is engaged with the first side of the first modular bed, and wherein the second seat of the coupler is engaged with the second side of the second modular bed.

2. The stackable bed system of claim 1, further comprising a third modular bed having a first side and a second side, wherein the first modular bed, the second modular bed, and the third modular bed are capable of forming a column, wherein one of the plurality of couplers is disposed on each corner of the second modular bed, wherein the first seat of the coupler is engaged with the first side of the second modular bed, and wherein the second seat of the coupler is engaged with the second side of the third modular bed.

3. The stackable bed system of claim 1, wherein the first modular bed comprises:
(a) a frame;
(b) a head support engaged with the frame; and
(c) one or more legs engaged with the frame.

4. The stackable bed system of claim 3, wherein the head support is an adjustable head support and is pivotally engaged with the frame.

5. The stackable bed system of claim 3, wherein the one or more legs are pivotally engaged with the frame as such to be capable of an extended position and a retracted position.

6. The stackable bed system of claim 3, wherein the first modular bed further comprises one or more safety rails configured to be engaged with the frame.

7. The stackable bed system of claim 1, further comprising a plurality of casters disposed on the second side of the first modular bed.

8. A compact, stackable bed system comprising:
(a) a plurality of modular beds, each modular bed comprising:
(i) a frame;
(ii) a head support; and
(iii) a foot support; and
(b) a plurality of couplers, each coupler comprising:
(i) a first seat and
(ii) a second seat spaced apart from the first seat,
wherein the plurality of modular beds are configured to be vertically stackable into a stacked column by insertion of one or more of the plurality of couplers between each of the plurality of modular beds.

9. The compact, stackable bed system of claim 8, wherein the stacked column has at least four couplers are disposed between each of the plurality of modular beds.

10. The compact, stackable bed system of claim 8, wherein the head support is an adjustable head support configured to be capable of being disposed at a plurality of angles with respect to the frame.

11. The compact, stackable bed system of claim 10, wherein the adjustable head support is adjustable via a first notched arm having one or more notches, the first notched arm pivotally engaged with the head support at its first end and the first notched arm engaged with a first locking bar via one of the one or more notches when the head support is in a raised configuration.

12. The compact, stackable bed system of claim 11, wherein the foot support is adjustable via a second notched arm having one or more notches, the second notched arm pivotally engaged with the foot support at its first end and the second notched arm engaged with a second locking bar via one of the one or more notches when the foot support is in a raised configuration.

13. The compact, stackable bed system of claim 8, further comprising an accessory attachment comprising:
(a) an elongate pole;
(b) a bracket disposed at a first end of the elongate pole, the bracket shaped for engagement with the frame of one or more of the plurality of modular beds; and
(c) a hook disposed at a second end of the elongate pole.

14. The compact, stackable bed system of claim 13, wherein the elongate pole is a telescoping pole.

15. A stackable, modular bed comprising:
(a) a frame;
(b) an adjustable head support within the frame;
(c) a foot support within the frame;
(d) one or more legs pivotally engaged with the frame, wherein each of the one or more legs comprises an extended position and a retracted position; and
(e) a removeable accessory attachment,
wherein the stackable, modular bed is configured to be vertically engaged with one or more further stackable, modular beds via one or more couplers.

16. The stackable, modular bed of claim 15, further comprising one or more handles extending from the adjustable head support.

17. The stackable, modular bed of claim 15, further comprising one or more side rails configured to be releasably engaged with the frame via a bracket.

18. The stackable, modular bed of claim 15, further comprising a plurality of casters, each of the casters configured to be releasably attached at an end of one of the one or more legs when the one or more legs are in the extended position.

19. The stackable, modular bed of claim 18, wherein each of the plurality of casters is configured to be releasably attached to a corner of the frame when the one or more legs are in the retracted position.

20. The stackable, modular bed of claim 15, further comprising an accessory attachment releasably engaged with the frame.
